(19) United States
(12) Patent Application Publication
(10) Pub. No.: US 2021/0341581 A1
(43) Pub. Date: Nov. 4, 2021

(54) PROCESSING DEVICE, SYSTEM, METHOD, AND NON-TRANSITORY COMPUTER READABLE MEDIUM

(71) Applicant: NEC CORPORATION, Tokyo (JP)

(72) Inventor: Yoshimasa ONO, Tokyo (JP)

(73) Assignee: NEC Corporation, Tokyo (JP)

(21) Appl. No.: 17/273,490

(22) PCT Filed: Sep. 6, 2018
(86) PCT No.: PCT/JP2018/032982

§ 371 Date: Mar. 4, 2021

(51) Int. Cl. G01S 7/48; G01S 17/42

(52) U.S. Cl. CPC G01S 7/4808; G01S 17/42

(57) ABSTRACT

Provided are a processing device, a system, a method, and a non-transitory computer readable medium capable of reducing false detection when detecting a foreign body. An acquisition means (111) that acquires first distance data (d1) between a predetermined point (pp) on a surface of an object (51) and a first measurement position (p1) outside the object (51) and acquires second distance data (d2) between the predetermined point (pp) and a second measurement position (p2) outside the object (51), a difference calculation means (112) that calculates difference data (dd) between the first distance data (d1) and the second distance data (d2), and a difference deletion means (113) that deletes a part of the first distance data (d1) or the second distance data (d2) on the basis of the difference data (dd) are included. The acquisition means (111) acquires the second distance data (d2) by assuming, as the predetermined point (pp), an intersection point (x1) between a line (L1) connecting the predetermined point (pp) and the second measurement position (p2) and the surface of the object (51).

### TECHNICAL FIELD

The present disclosure relates to a processing device, a system, a method, and a non-transitory computer readable medium and, particularly, to a processing device, a system, a method, and a non-transitory computer readable medium capable of reducing false detection when detecting a foreign body.

### BACKGROUND ART

Birds can build nests in power facilities such as electrical substations. A bird's nest built on electrical wires of power facilities can result in short-circuit of electrical wires, which can cause a massive power failure. To prevent this, a foreign body is detected by acquiring distance data to an object three-dimensionally with use of a laser rangefinder (LiDAR: Light Detection and Ranging), comparing it with an observation result before nest building, and calculating their difference.

Patent Literature 1 describes a method that performs laser scanning of a building from a first viewpoint to obtain 3D point group position data, captures, from a second viewpoint, stereo pair images of a part of the building that is occluded from the first viewpoint, then calculates the correspondence between stereo images obtained at the second viewpoint and the 3D point group position data obtained at the first viewpoint, and thereby performs calibration of a stereo pair imaging device by using the 3D point group position data. Further, Patent Literature 1 describes a method that removes 3D point group position data of a non-plane region from 3D point group position data. To be specific, Patent Literature 1 describes a method that compares a local curvature with a preset threshold and determines a local region with a local curvature exceeding the threshold as a non-plane region, a method that calculates the distance between each point in a local region and a corresponding local plane and, when the average of the distances is greater than a preset threshold, determines this local region as a non-plane region, and a method that compares the orientation of corresponding local planes in adjacent local regions and, when a difference in the orientation of the local planes exceeds the threshold, determines the compared local regions belong to a non-plane region. However, Patent Literature 1 does not describe a technique that acquires first distance data between an object and a first measurement position, acquires second distance data between the object and a second measurement position, and deletes part of the first distance data or the second distance data on the basis of difference data between the first distance data and the second distance data.

According to Patent Literature 2, a road surface region point group detection unit performs clustering of a point group made up of 3D points with a small plane approximation error in a 3D point group by using the similarity of 3D points in the normal direction, and thereby detects a 3D point group cluster as a road surface region point group. It describes a method that estimates, by a depression estimation unit, estimates a plane in each of 3D points so as to optimize an evaluation function that evaluates the smoothness of coupling a candidate plane obtained locally for 3D points in the road surface region point group and a candidate plane obtained locally for 3D points in its vicinity and the likelihood of candidate planes, performs clustering of a point group made up of 3D points located vertically lower than the estimated plane, and estimates, as the depth of depression, the maximum value of the distance between the 3D points belonging to the cluster and the estimated plane in the normal direction. Further, Patent Literature 2 describes that a point group in a road region divided by the effect of a vehicle running in parallel or an oncoming vehicle, which is divided into another cluster, is integrated using height information. Furthermore, Patent Literature 2 describes that a depressed point group located on the periphery of the road surface region point group id integrated. However, Patent Literature 2 does not describe a technique that acquires first distance data between an object and a first measurement position, acquires second distance data between the object and a second measurement position, and deletes part of the first distance data or the second distance data on the basis of difference data between the first distance data and the second distance data.

### CITATION LIST

### Patent Literature

PTL1: Japanese Unexamined Patent Application Publication No. 2012-88114

PTL2: Japanese Unexamined Patent Application Publication No. 2018-71973

### SUMMARY OF INVENTION

### Technical Problem

As described above, a foreign body such as a bird's nest has been detected by using a laser rangefinder. However, this has a problem that the measurement position of the laser rangefinder before nest building and the measurement position of the laser rangefinder after nest building are different, which can cause false detection.

An object of the present disclosure is to provide a processing device, a system, a method, and a non-transitory computer readable medium that solve any of the above-described problems.

### Solution to Problem

A processing device according to the present disclosure includes an acquisition means for acquiring first distance data between a predetermined point on a surface of an object and a first measurement position outside the object, and acquiring second distance data between the predetermined point and a second measurement position outside the object, a difference calculation means for calculating difference data between the first distance data and the second distance data, and a difference deletion means for deleting a part of the first distance data or the second distance data on the basis of the difference data, wherein when the second distance data cannot be measured due to interruption by a part of the object, the acquisition means acquires the second distance data by assuming, as the predetermined point, an intersection point between a line connecting the predetermined point and the second measurement position and the surface of the object, at which a distance between the object and the second measurement position is shortest.

A system according to the present disclosure includes a distance measurement device, a processing device, and a foreign body detection device, wherein the distance measurement device measures first distance data between a predetermined point on a surface of an object and a first measurement position outside the object, and measures second distance data between the predetermined point and a second measurement position outside the object, the processing device includes an acquisition means for acquiring the first distance data and the second distance data, a difference calculation means for calculating difference data between the first distance data and the second distance data, and a difference deletion means for deleting a part of the first distance data or the second distance data on the basis of the difference data, and when the second distance data cannot be measured due to interruption by a part of the object, the acquisition means acquires the second distance data by assuming, as the predetermined point, an intersection point between a line connecting the predetermined point and the second measurement position and the surface of the object, at which a distance between the object and the second measurement position is shortest, and the foreign body detection device detects a foreign body on the basis of the first distance data after the deletion and the second distance data after the deletion.

A method according to the present disclosure includes acquiring first distance data between a predetermined point on a surface of an object and a first measurement position outside the object, acquiring second distance data between the predetermined point and a second measurement position outside the object, calculating difference data between the first distance data and the second distance data, deleting a part of the first distance data or the second distance data on the basis of the difference data, and when the second distance data cannot be measured due to interruption by a part of the object, acquiring the second distance data by assuming, as the predetermined point, an intersection point between a line connecting the predetermined point and the second measurement position and the surface of the object, at which a distance between the object and the second measurement position is shortest.

A non-transitory computer readable medium according to the present disclosure stores a program causing a computer to perform acquiring first distance data between a predetermined point on a surface of an object and a first measurement position outside the object, acquiring second distance data between the predetermined point and a second measurement position outside the object, calculating difference data between the first distance data and the second distance data, deleting a part of the first distance data or the second distance data on the basis of the difference data, and when the second distance data cannot be measured due to interruption by a part of the object, acquiring the second distance data by assuming, as the predetermined point, an intersection point between a line connecting the predetermined point and the second measurement position and the surface of the object, at which a distance between the object and the second measurement position is shortest.

### Advantageous Effects of Invention

According to the present disclosure, there are provided a processing device, a system, a method, and a non-transitory computer readable medium capable of reducing false detection when detecting a foreign body.

### BRIEF DESCRIPTION OF DRAWINGS

FIG. 1 is a block diagram illustrating a processing device according to an example embodiment.

FIG. 2 is a block diagram illustrating a system according to the example embodiment.

FIG. 3 is a view illustrating measurement of distance data by a distance measurement device according to the example embodiment.

FIG. 4 is a flowchart illustrating the operation of the system according to the example embodiment.

FIG. 5 is a flowchart illustrating the operation of a difference deletion means according to the example embodiment.

FIG. 6 is a view illustrating an object and the distance measurement device viewed from above (in the Z-direction).

FIG. 7 is a flowchart illustrating the operation of the difference deletion means according to the example embodiment.

FIG. 8 is a view illustrating second distance data by the distance measurement device according to the example embodiment.

FIG. 9 is a view illustrating an object and the distance measurement device viewed from above (in the Z-direction).

FIG. 10 is a view schematically illustrating overlapping of distance data with respect to an object.

FIG. 11 is a graph illustrating second distance data and difference data.

FIG. 12 is a graph illustrating the proportion of difference data shown in FIG. 11.

FIG. 13 is a flowchart illustrating the operation of the difference deletion means according to the example embodiment.

### DESCRIPTION OF EMBODIMENTS

An example embodiment of the present invention will be described hereinafter with reference to the drawings. In the figures, the identical reference symbols denote identical structural elements and the redundant explanation thereof is omitted according to need.

### EXAMPLE EMBODIMENT

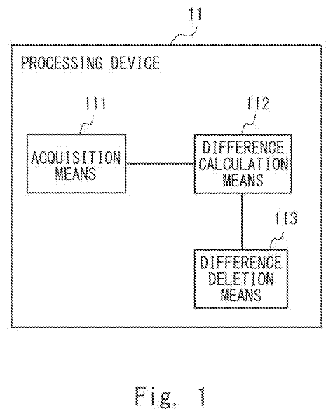

FIG. 1 is a block diagram illustrating a processing device according to an example embodiment.

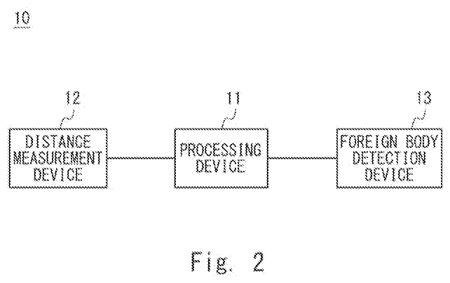

FIG. 2 is a block diagram illustrating a system according to the example embodiment.

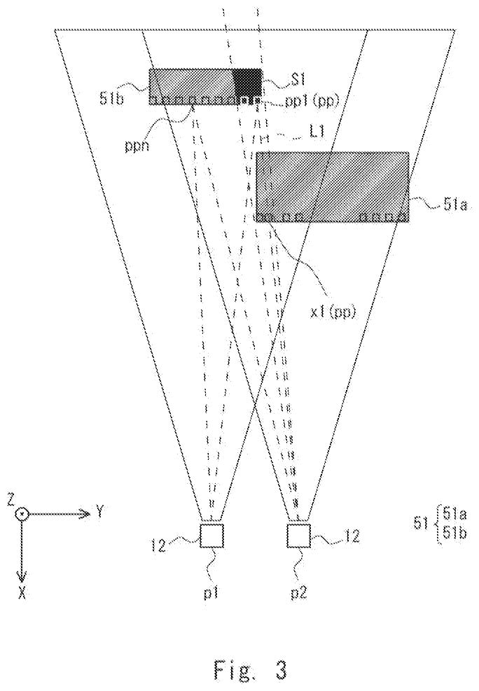

FIG. 3 is a view illustrating measurement of distance data by a distance measurement device according to the example embodiment.

FIG. 3 is a view illustrating an object and the distance measurement device viewed from above (in the Z-direction).

As shown in FIG. 1, a processing device 11 according to the example embodiment includes an acquisition means 111, a difference calculation means 112, and a difference deletion means 113.

As shown in FIG. 2, a system 10 according to the example embodiment includes a distance measurement device 12, the processing device 11, and a foreign body detection device 13.

First, a shadow when measuring distance data by the distance measurement device 12 is described.

As shown in FIG. 3, the position at which the distance measurement device 12 is placed before nest building is a first measurement position p1. The position at which the distance measurement device 12 is placed after nest building is a second measurement position p2. The first measurement position p1 and the second measurement position p2 are measurement positions at which the distance measurement device 12 is placed before and after nest building, respectively, and they are not necessarily the same positions and slightly displaced from each other. Further, in the example shown in FIG. 3, an object 51 is made up of separated object 51a and object 51b.

The distance measurement device 12 measures first distance data d1 indicating the distance between a predetermined point pp on the surface of the object 51 and the first measurement position p1 outside the object 51. The distance measurement device 12 measures second distance data d2 indicating the distance between the predetermined point pp and the second measurement position p2 outside the object 51. To be specific, a plurality of points ppn exist on the surface of the object 51, and the distance measurement device 12 measures first distance data d11 between a first predetermined point pp1 among the plurality of points ppn and the first measurement position p1. Further, the distance measurement device 12 measures second distance data d21 between the first predetermined point pp1 and the second measurement position p2. Note that “n” of the plurality of points ppn is an integer. The distance measurement device 12 measures the distance from the same first predetermined point pp1 both when measuring the first distance data d11 and the second distance data d21.

The processing device 11 may further include a display unit that displays, together with the object 51, the predetermined point pp on the surface of the object 51 corresponding to the first distance data d1 or the second distance data d2.

Note that a plurality of first distance data d1 acquired as a result of measuring the distance between each of the plurality of points ppn on the surface of the object 51 and the first measurement position p1 are referred to as a first point group in some cases. Further, a plurality of second distance data d2 acquired as a result of measuring the distance between each of the plurality of points ppn on the surface of the object 51 and the second measurement position p2 are referred to as a second point group in some cases.

A plurality of predetermined points pp on the surface of the object 51 may be equally spaced from one another.

The plurality of predetermined points pp on the surface of the object 51 may be arranged along the Y-direction and also along the Z-direction perpendicular to the Y-direction. The Y-direction is referred to as a first direction, and the Z-direction is referred to as a second direction in some cases.

When measuring the distance from the plurality of points ppn, there is a case where the second distance data d2 cannot be measured due to interruption by the object 51a, which is a part of the object 51. This occurs when the distance measurement device 12 measures the second distance data d2 between the first predetermined point pp1 on the surface of the object 51b and the second measurement position p2, for example. A part of the object 51 where the distance measurement device 12 cannot measure the second distance data d2 is referred to as a shadow S1. The shadow S1 arises because the first measurement position p1 and the second measurement position p2 are different. The shadow S1 occurs due to a difference in the measurement position of the distance measurement device 12.

When the second distance data d2 cannot be measured due to interruption by the object 51a, the distance measurement device 12 measures the second distance data d2, assuming an intersection point x1 between a line L1 connecting the first predetermined point pp1 and the second measurement position p2 and the surface of the object 51 as the predetermined point pp. The intersection point x1 is a point at which the distance between the object 51 and the second measurement position p2 is shortest in the line L1.

The first distance data d1 between the first predetermined point pp1 on the surface of the object 51b and the first measurement position p1 is correctly measured. However, the second distance data d2 between the first predetermined point pp1 on the surface of the object 51b and the second measurement position p2 is not correctly measured due to interruption by the object 51a.

Consequently, an excessively large difference occurs between the first distance data d1 and the second distance data d2. When a difference between the first distance data d1 and the second distance data d2 is equal to or greater than a predetermined difference threshold, it is determined that there is a foreign body. Thus, it is erroneously determined that there is a foreign body regardless of the fact that there is no foreign body because of the effect of the shadow S1 that occurs due to a difference in the measurement position of the distance measurement device 12. In order to reduce false detection of a foreign body when there is no foreign body, it is necessary to delete a part of the first distance data d1 or the second distance data d2 corresponding to the shadow S1.

Therefore, the processing device 11 according to the example embodiment deletes a part of the first distance data d1 or the second distance data d2 corresponding to the shadow S1 as described below and thereby reduces false detection when detecting a foreign body.

The operation of the system according to the example embodiment is described hereinafter.

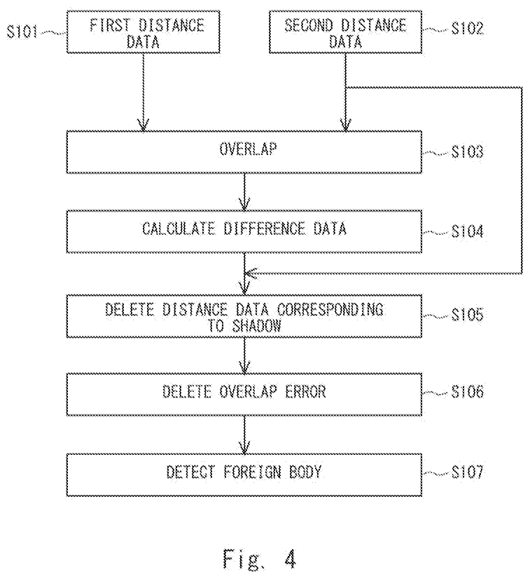

FIG. 4 is a flowchart illustrating the operation of the system according to the example embodiment.

As shown in FIG. 4, the acquisition means 111 acquires the first distance data d1, which is the distance between the predetermined point pp on the surface of the object 51 and the first measurement position p1 outside the object 51 (S101).

The acquisition means 111 acquires the second distance data d2, which is the distance between the predetermined point pp and the second measurement position p2 outside the object 51 (S102). The acquisition means 111 acquires the first distance data d1 and the second distance data d2 measured by the distance measurement device 12.

When the second distance data d2 cannot be measured due to interruption by the object 51a as shown in FIG. 3, the acquisition means 111 acquires the second distance data d2, assuming the intersection point x1 between the line L1 connecting the first predetermined point pp1 and the second measurement position p2 and the surface of the object 51 as the predetermined point pp. The intersection point x1 is a point at which the distance between the object 51 and the second measurement position p2 is shortest in the line L1. The acquisition means 111 acquires the second distance data d2 measured by the distance measurement device 12.

The difference calculation means 112 overlaps the first distance data d1 and the second distance data d2 in order to calculate difference data dd, which is a difference between the first distance data d1 and the second distance data d2 (Step S103).

The difference calculation means 112 calculates the difference data dd between the first distance data d1 and the second distance data d2 (Step S104).

The first distance data d1 is the distance between each of the plurality of points ppn and the first measurement position p1. Thus, there are a plurality of first distance data d1. The second distance data d2 is the distance between each of the plurality of points ppn and the second measurement position p2. Thus, there are a plurality of second distance data d2. The difference data dd is a difference between the first distance data d1 and the second distance data d2. Thus, there are a plurality of difference data dd. One of the difference data dd is a difference between first distance data d11 corresponding to the first predetermined point pp1 among the plurality of points ppn and second distance data d21 corresponding to the first predetermined point pp1 among the plurality of points ppn. When calculating the difference data dd, a difference between the first distance data d1 and the second distance data d2 corresponding to the same predetermined point pp is calculated. There are a plurality of difference data dd, which are referred to as a difference point group in some cases.

On the basis of the difference data dd, the difference deletion means 113 deletes a part of the first distance data d1 or the second distance data d2 corresponding to the shadow S1 that occurs due to a difference between the first measurement position p1 and the second measurement position p2 (Step S105). Note that, in some cases, the first distance data d1 and the second distance data d2 are collectively referred to simply as distance data.

The details of Step S105 are described hereinafter.

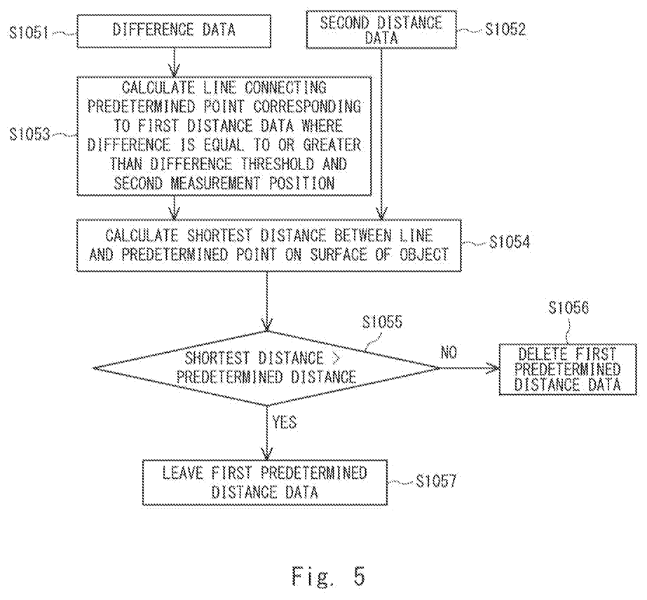

FIG. 5 is a flowchart illustrating the operation of the difference deletion means according to the example embodiment.

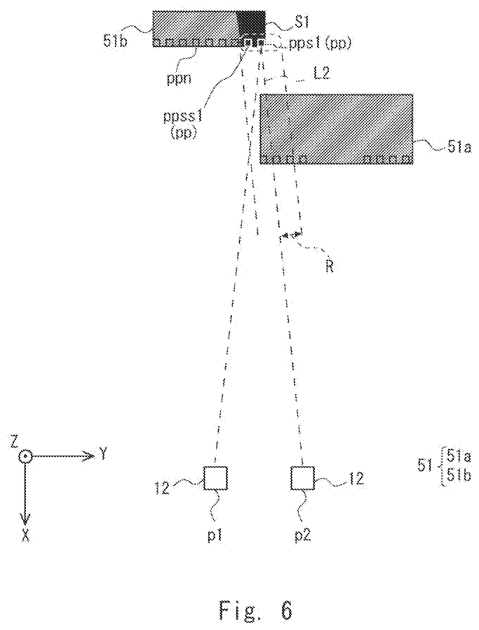

FIG. 6 is a view illustrating an object and the distance measurement device viewed from above (in the Z-direction).

As shown in FIG. 5, the difference deletion means 113 acquires the difference data dd from the difference calculation means 112 (Step S1051).

The difference deletion means 113 acquires the second distance data d2 from the acquisition means 111 (Step S1052).

The difference deletion means 113 specifies the first distance data d1 where the difference data dd is equal to or greater than a difference threshold as first difference distance data dd1. As shown in FIG. 6, the difference deletion means 113 specifies the predetermined point pp on the surface of the object 51 corresponding to the first difference distance data dd1 as a first specific point pps1. The difference deletion means 113 calculates a line L2 connecting the first specific point pps1 and the second measurement position p2 (Step S1053).

The difference deletion means 113 calculates the shortest distance between the line L2 and the predetermined point pp on the surface of the object 51 (Step S1054).

The difference deletion means 113 determines whether the calculated shortest distance is longer than a predetermined distance R (Step S1055).

When the calculated shortest distance is not longer than the predetermined distance R (Step S1055: No), the difference deletion means 113 specifies the predetermined point pp on the surface of the object 51 corresponding to the shortest distance as a first predetermined specific point ppss1. Specifically, the difference deletion means 113 specifies the predetermined point pp on the surface of the object 51 which is included within the predetermined distance R from the calculated line L2 as the first predetermined specific point ppss1.

When Step S1055 results in No, the difference deletion means 113 specifies the first distance data d1 corresponding to the first predetermined specific point ppss1 as first predetermined distance data d1r. The difference deletion means 113 deletes the first predetermined distance data d1r (Step S1056).

When the calculated shortest distance is longer than the predetermined distance R (Step S1055: Yes), the difference deletion means 113 leaves the first predetermined distance data d1r (Step S1057).

The first predetermined distance data d1r, which is the first distance data d1 corresponding to the shadow S1, is thereby deleted, and false detection is reduced when detecting a foreign body.

Another method of Step S105 is described hereinafter.

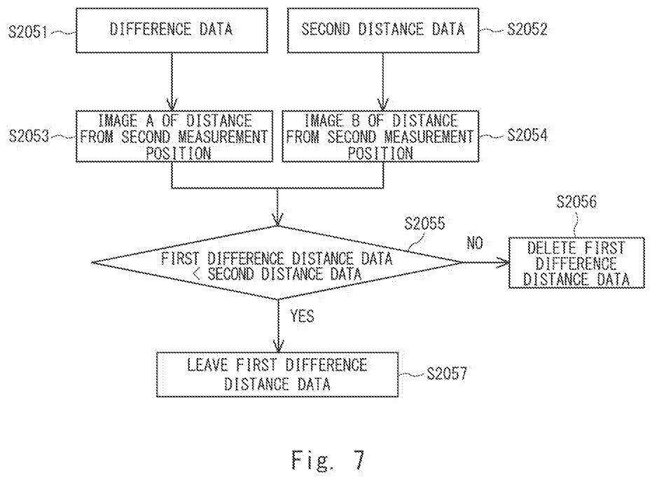

FIG. 7 is a flowchart illustrating the operation of the difference deletion means according to the example embodiment.

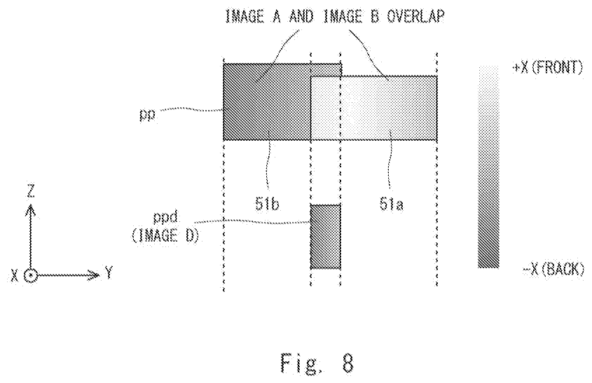

FIG. 8 is a view illustrating the second distance data by the distance measurement device according to the example embodiment.

FIG. 8 shows the distance between an object and the distance measurement device by the gray scale of an image. The dark color indicates that the distance is long, and the light color indicates that the distance is short.

FIG. 8 shows an image A of the distance and an image B of the distance overlapping each other.

FIG. 8 also shows an image D of a difference point ppd, which is the predetermined point pp on the surface of the object 51 corresponding to the first difference distance data.

FIG. 8 is a view in which the object is viewed from the front (in the X-direction).

As shown in FIG. 7, the difference deletion means 113 acquires the difference data dd from the difference calculation means 112 (Step S2051). The difference deletion means 113 specifies the first distance data d1 where the difference data dd is equal to or greater than a difference threshold as the first difference distance data dd1.

The difference deletion means 113 acquires the second distance data d2 from the acquisition means 111 (Step S2052).

As shown in FIG. 8, the difference deletion means 113 sets the first difference distance data dd1 as an image A of the distance from the second measurement position p2 (Step S2053).

The difference deletion means 113 sets the second distance data d2 as an image B of the distance from the second measurement position p2 (Step S2054).

The difference deletion means 113 determines whether the distance data of the image A is shorter than the distance data of the image B (Step S2055). In other words, the difference deletion means 113 determines whether the first difference distance data dd1 is shorter than the second distance data d2.

When the distance data of the image A is shorter than the distance data of the image B (Step S2055: Yes), the difference deletion means 113 leaves the first difference distance data dd1 (Step S2057). In other words, when the first difference distance data dd1 is shorter than the second distance data d2, the difference deletion means 113 leaves the first difference distance data dd1.

When, on the other hand, the distance data of the image A is not shorter than the distance data of the image B (Step S2055: No), the difference deletion means 113 deletes the first difference distance data dd1 (Step S2056). In other words, the difference deletion means 113 deletes the first difference distance data dd1 that is greater than the second distance data d2.

The difference threshold may be a value greater than 0.

The first difference distance data dd1, which is the first distance data d1 corresponding to the shadow S1, is thereby deleted, and false detection is reduced when detecting a foreign body.

Then, after Step S105 in FIG. 4, the difference deletion means 113 deletes an error caused by overlapping (Step S106).

An error by overlapping is described hereinafter.

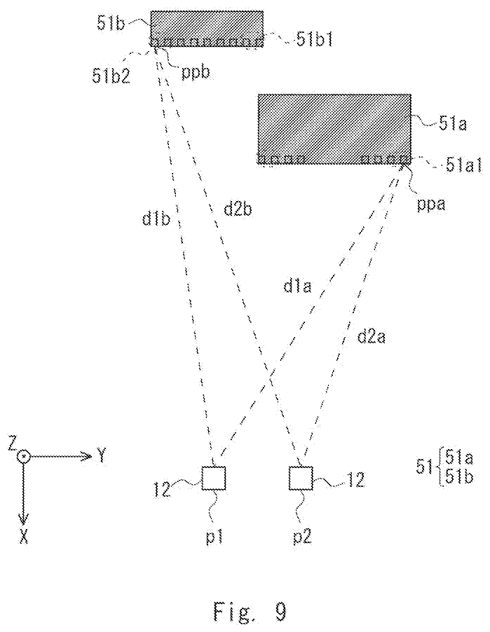

FIG. 9 is a view illustrating an object and the distance measurement device viewed from above (in the Z-direction).

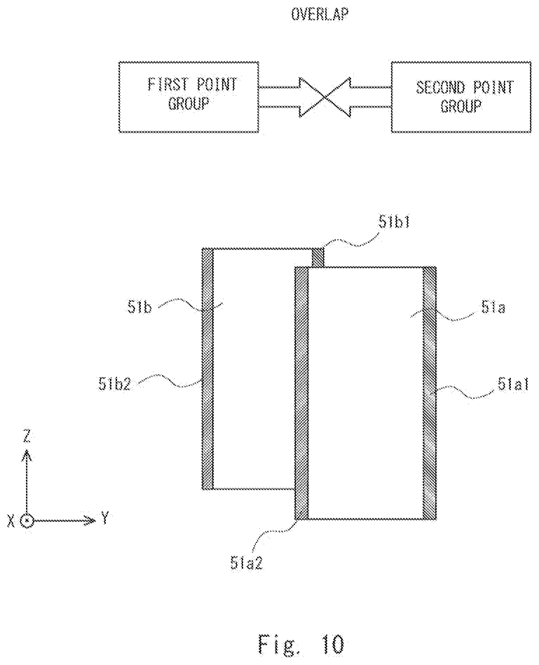

FIG. 10 is a view schematically illustrating overlapping distance data with respect to an object.

As shown in FIG. 9, difference data between first distance data d1a and second distance data d2a is greater than other difference data. Likewise, difference data between first distance data d1b and second distance data d2b is greater than other difference data. FIG. 10 schematically shows this. As shown in FIG. 10, an error of distance data is large at an end 51a1 and an end 51a2 of the object 51a and at an end 51b1 and an end 51b2 of the object 51b.

Note that the first distance data d1a is the distance between a predetermined point ppa and the first measurement position p1, and the second distance data d2a is the distance between the predetermined point ppa and the second measurement position p2. Further, the first distance data d1b is the distance between a predetermined point ppb and the first measurement position p1, and the second distance data d2b is the distance between the predetermined point ppb and the second measurement position p2.

In the detection of a foreign body, it is determined that there is a foreign body when a difference between the first distance data d1 and the second distance data d2 is equal to or greater than a predetermined difference threshold, for example. Due to the effect of an error in distance data caused by overlapping the distance data, it can be determined that there is a foreign body even when there is no foreign body. Therefore, it is necessary to delete a part of the first distance data d1 or the second distance data d2 in order to reduce the effect of an error in distance data.

Study of an error in distance data caused by overlapping is as follows.

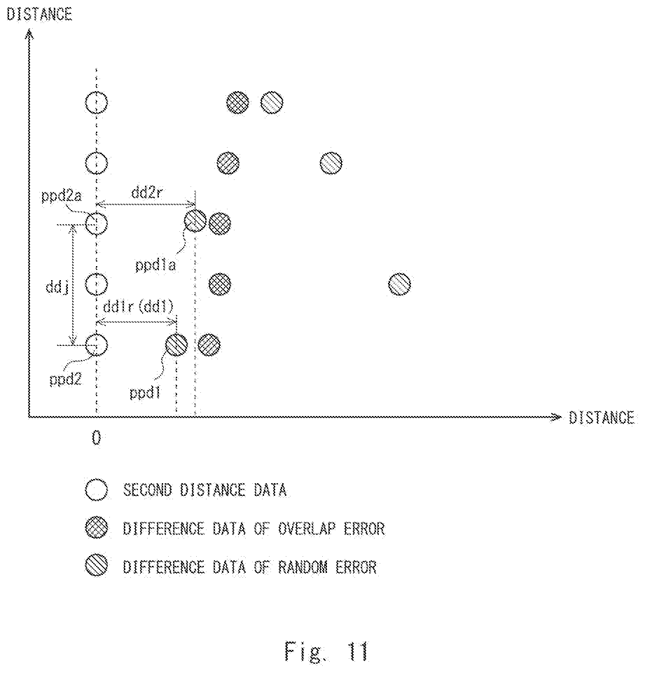

FIG. 11 is a graph illustrating second distance data and difference data.

In FIG. 11, the vertical axis indicates the distance, and the vertical axis indicates the distance.

FIG. 11 shows the difference data with reference to the second distance data.

FIG. 11 shows difference data of an overlap error and difference data of a random error.

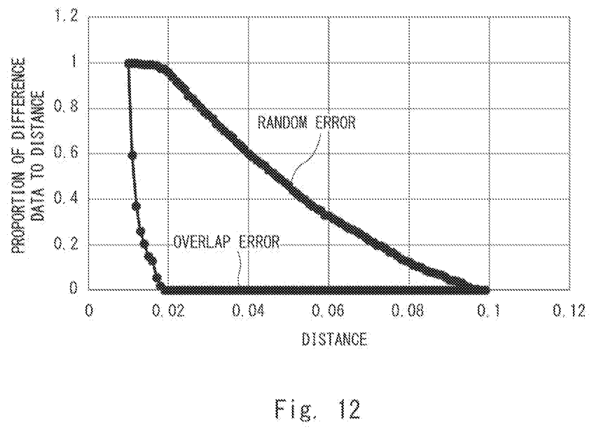

FIG. 12 is a graph illustrating the proportion of the difference data shown in FIG. 11.

In FIG. 12, the vertical axis indicates the proportion of the difference data to the distance, and the vertical axis indicates the distance.

As shown in FIG. 11, the distance of the second distance data is 0 because it is with reference to its own data. The first difference distance data dd1 shown in FIG. 11 is a difference between the first distance data d1a and the second distance data d2a shown in FIG. 9, for example. Note that an error caused by overlapping is referred to as an overlap error.

As shown in FIGS. 11 and 12, the difference data of an overlap error is not widely dispersed, and it is distributed “in a plane” with respect to an object (construction). On the other hand, the difference data before and after nest building is widely dispersed, and it is distributed “at random” with respect to an object. This is referred to as a random error. Thus, the dispersion in the difference data of an overlap error is smaller than the dispersion in the difference data of a random error.

Therefore, the difference deletion means 113 of the processing device 11 according to the example embodiment deletes a part of the first distance data d1 or the second distance data d2 as follows in order to reduce the effect of an error in distance data caused by overlapping.

The difference deletion means 113 performs Step S106 shown in FIG. 4.

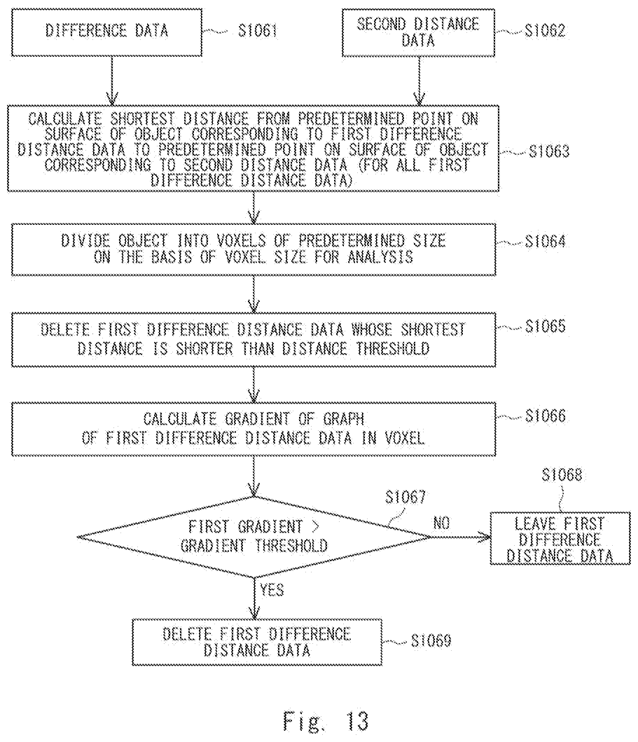

FIG. 13 is a flowchart illustrating the operation of the difference deletion means according to the example embodiment.

As shown in FIG. 13, the difference deletion means 113 acquires the difference data dd from the difference calculation means 112 (Step S1061). The difference deletion means 113 specifies the first distance data d1 where the difference data dd is equal to or greater than a difference threshold as the first difference distance data dd1.

The difference deletion means 113 acquires the second distance data d2 from the acquisition means 111 (Step S1062).

The difference deletion means 113 calculates the shortest distance from a specified point on the surface of the object 51 corresponding to the first difference distance data dd1 to a specified point on the surface of the object 51 corresponding to the second distance data d2 (Step S1063).

To be specific, as shown in FIG. 11, the difference deletion means 113 specifies the predetermined point pp on the surface of the object 51 corresponding to the first difference distance data dd1 as a first difference point ppd1. The difference deletion means 113 specifies the second distance data d2 where the difference data dd is equal to or greater than a difference threshold as second difference distance data dd2. The difference deletion means 113 specifies the predetermined point pp on the surface of the object 51 corresponding to the second difference distance data dd2 as a second difference point ppd2.

The difference deletion means 113 specifies the predetermined point pp on the surface of the object 51 which is adjacent to the first difference point ppd1 as an adjacent first difference point ppd1a. The difference deletion means 113 specifies the predetermined point pp on the surface of the object 51 which is adjacent to the second difference point as an adjacent second difference point ppd2a.

The difference deletion means 113 calculates first predetermined difference distance data dd1r between the first difference point ppd1 and the second difference point ppd2. Specifically, it calculates the first predetermined difference distance data dd1r, which is the shortest distance from the first difference point ppd1 on the surface of the object 51 corresponding to one of the first difference distance data dd1 to the second difference point ppd2 on the surface of the object 51 corresponding to one of the second distance data d2. This calculation is performed on all of the first difference distance data dd1 (Step S1063).

The difference deletion means 113 divides the object 51 into voxels of a predetermined size on the basis of a voxel size for analysis (Step S1064).

The difference deletion means 113 deletes the first difference distance data dd1 where the calculated shortest distance is shorter than a distance threshold (Step S1065).

The difference deletion means 113 calculates the gradient of the graph of the difference data dd (first difference distance data dd1) shown in FIG. 11 (Step S1066).

To be specific, as shown in FIG. 11, the difference deletion means 113 calculates second predetermined difference distance data dd2r between the adjacent first difference point ppd1a and the adjacent second difference point ppd2a. The difference deletion means 113 calculates adjacent difference distance data ddj between the second difference point ppd2 and the adjacent second difference point ppd2a. The difference deletion means 113 divides the adjacent difference distance data ddj by a distance obtained by subtracting the first predetermined difference distance data dd1r from the second predetermined difference distance data dd2r, and thereby calculates a first gradient.

The difference deletion means 113 determines whether the first gradient is greater than a gradient threshold (Step S1067). Note that the first gradient is referred to simply as a gradient in some cases.

When the first gradient is equal to or smaller than the gradient threshold (Step S1067: No), the difference deletion means 113 leaves the first difference distance data dd1 (Step S1068).

When, on the other hand, the first gradient is greater than the gradient threshold (Step S1067: Yes), the difference deletion means 113 deletes the first difference distance data dd1 (Step S1069).

The effect of an error in distance data caused by overlapping is thereby reduced, and false detection is reduced when detecting a foreign body.

Then, after Step S106 in FIG. 4, the foreign body detection device 13 detects a foreign body on the basis of the first distance data d1 after deletion and the second distance data d2 after deletion (Step S107). To be specific, it calculates a difference between the first distance data d1 after deletion and the second distance data d2 after deletion, and when the calculated difference is equal to or greater than a predetermined difference threshold, determines that there is a foreign body and detects (extracts) the foreign body.

As described above, according to the example embodiment, there are provided a processing device, a system, a method, and a non-transitory computer readable medium capable of reducing false detection when detecting a foreign body.

Although the resent invention is described as a hardware configuration in the above example embodiment, it is not limited thereto. The present invention may be implemented by causing a CPU (Central Processing Unit) to execute a computer program to perform given processing.

In the above-described example embodiment, the program can be stored using any type of non-transitory computer readable media and provided to a computer. The non-transitory computer readable media include any type of tangible storage media. Examples of non-transitory computer readable media include magnetic storage media such as flexible disks, magnetic tapes or hard disks, optical magnetic storage media such as magneto-optical disks, optical disc media such as CD (Compact Disc) or DVD (Digital Versatile Disk), and semiconductor memories such as mask ROM, PROM (Programmable ROM), EPROM (Erasable PROM), flash ROM or RAM (Random Access Memory). The program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers, or a wireless communication line.

While the present invention has been particularly shown and described with reference to an example embodiment thereof, the present invention is not limited thereto. It will be understood by those of ordinary skill in the art that various changes may be made therein without departing from the scope of the present invention.

Note that the present invention is not limited to the above-described example embodiment and can be modified as appropriate without departing from the spirit and scope of the present disclosure.

For example, the whole or part of the example embodiment disclosed above can be described as, but not limited to, the following supplementary notes.

### (Supplementary Note 1)

A processing device comprising:

an acquisition means for acquiring first distance data between a predetermined point on a surface of an object and a first measurement position outside the object, and acquiring second distance data between the predetermined point and a second measurement position outside the object;

a difference calculation means for calculating difference data between the first distance data and the second distance data; and

a difference deletion means for deleting a part of the first distance data or the second distance data on the basis of the difference data,

wherein when the second distance data cannot be measured due to interruption by a part of the object, the acquisition means acquires the second distance data by assuming, as the predetermined point, an intersection point between a line connecting the predetermined point and the second measurement position and the surface of the object, at which a distance between the object and the second measurement position is shortest.

### (Supplementary Note 2)

The processing device according to Supplementary Note 1, wherein the difference deletion means

specifies the first distance data where the difference data is equal to or greater than a difference threshold as first difference distance data,

specifies the predetermined point on the surface of the object corresponding to the first difference distance data as a first specific point,

specifies the predetermined point on the surface of the object included within a predetermined distance from a line connecting the first specific point and the second measurement position as a first predetermined specific point,

specifies the first distance data corresponding to the first predetermined specific point as first predetermined distance data, and deletes the first predetermined distance data.

### (Supplementary Note 3)

The processing device according to Supplementary Note 1, wherein the difference deletion means

specifies the first distance data where the difference data is equal to or greater than a difference threshold as first difference distance data, and

deletes the first difference distance data equal to or greater than the second distance data.

### (Supplementary Note 4)

The processing device according to Supplementary Note 3, wherein the difference threshold is equal to or greater than 0.

### (Supplementary Note 5)

The processing device according to any one of Supplementary Notes 1 to 4, wherein the difference deletion means

specifies the first distance data where the difference data is equal to or greater than a difference threshold as first difference distance data,

specifies the predetermined point on the surface of the object corresponding to the first difference distance data as a first difference point,

specifies the second distance data where the difference data is equal to or greater than the difference threshold as second difference distance data,

specifies the predetermined point on the surface of the object corresponding to the second difference distance data as a second difference point,

specifies the predetermined point on the surface of the object adjacent to the first difference point as an adjacent first difference point,

specifies the predetermined point on the surface of the object adjacent to the second difference point as an adjacent second difference point,

calculates first predetermined difference distance data between the first difference point and the second difference point,

calculates second predetermined difference distance data between the adjacent first difference point and the adjacent second difference point,

calculates adjacent difference distance data between the second difference point and the adjacent second difference point,

calculates a first gradient by dividing the adjacent difference distance data by a distance obtained by subtracting the first predetermined difference distance data from the second predetermined difference distance data, and

when the first gradient is greater than a gradient threshold, deletes the first difference distance data.

### (Supplementary Note 6)

The processing device according to any one of Supplementary Notes 1 to 5, wherein a plurality of predetermined points on the surface of the object are equally spaced from one another.

### (Supplementary Note 7)

The processing device according to any one of Supplementary Notes 1 to 6, wherein a plurality of predetermined points on the surface of the object are arranged along a first direction and arranged along a second direction perpendicular to the first direction.

### (Supplementary Note 8)

The processing device according to any one of Supplementary Notes 1 to 7, further comprising:

a display unit configured to display the predetermined point on the surface of the object corresponding to the first distance data or the second distance data together with the object.

### (Supplementary Note 9)

A system comprising:

a distance measurement device;

a processing device; and

a foreign body detection device, wherein

the distance measurement device measures first distance data between a predetermined point on a surface of an object and a first measurement position outside the object, and measures second distance data between the predetermined point and a second measurement position outside the object,

the processing device includes:

an acquisition means for acquiring the first distance data and the second distance data;

a difference calculation means for calculating difference data between the first distance data and the second distance data; and

a difference deletion means for deleting a part of the first distance data or the second distance data on the basis of the difference data, and

when the second distance data cannot be measured due to interruption by a part of the object, the acquisition means acquires the second distance data by assuming, as the predetermined point, an intersection point between a line connecting the predetermined point and the second measurement position and the surface of the object, at which a distance between the object and the second measurement position is shortest, and

the foreign body detection device detects a foreign body on the basis of the first distance data after the deletion and the second distance data after the deletion.

### (Supplementary Note 10)

The system according to Supplementary Note 9, wherein the difference deletion means

specifies the first distance data where the difference data is equal to or greater than a difference threshold as first difference distance data,

specifies the predetermined point on the surface of the object corresponding to the first difference distance data as a first specific point,

specifies the predetermined point on the surface of the object included within a predetermined distance from a line connecting the first specific point and the second measurement position as a first predetermined specific point,

specifies the first distance data corresponding to the first predetermined specific point as first predetermined distance data, and

deletes the first predetermined distance data.

### (Supplementary Note 11)

The system according to Supplementary Note 9, wherein the difference deletion means

specifies the first distance data where the difference data is equal to or greater than a difference threshold as first difference distance data, and

deletes the first difference distance data equal to or greater than the second distance data.

### (Supplementary Note 12)

The system according to any one of Supplementary Notes 9 to 11, wherein the difference deletion means

specifies the first distance data where the difference data is equal to or greater than a difference threshold as first difference distance data,

specifies the predetermined point on the surface of the object corresponding to the first difference distance data as a first difference point,

specifies the second distance data where the difference data is equal to or greater than the difference threshold as second difference distance data,

specifies the predetermined point on the surface of the object corresponding to the second difference distance data as a second difference point,

specifies the predetermined point on the surface of the object adjacent to the first difference point as an adjacent first difference point,

specifies the predetermined point on the surface of the object adjacent to the second difference point as an adjacent second difference point,

calculates first predetermined difference distance data between the first difference point and the second difference point,

calculates second predetermined difference distance data between the adjacent first difference point and the adjacent second difference point,

calculates adjacent difference distance data between the second difference point and the adjacent second difference point,

calculates a first gradient by dividing the adjacent difference distance data by a distance obtained by subtracting the first predetermined difference distance data from the second predetermined difference distance data, and

when the first gradient is greater than a gradient threshold, deletes the first difference distance data.

### (Supplementary Note 13)

A method comprising:

acquiring first distance data between a predetermined point on a surface of an object and a first measurement position outside the object;

acquiring second distance data between the predetermined point and a second measurement position outside the object;

calculating difference data between the first distance data and the second distance data; and

deleting a part of the first distance data or the second distance data on the basis of the difference data,

when the second distance data cannot be measured due to interruption by a part of the object, acquiring the second distance data by assuming, as the predetermined point, an intersection point between a line connecting the predetermined point and the second measurement position and the surface of the object, at which a distance between the object and the second measurement position is shortest.

### (Supplementary Note 14)

A non-transitory computer readable medium storing a program causing a computer to perform:

acquiring first distance data between a predetermined point on a surface of an object and a first measurement position outside the object;

acquiring second distance data between the predetermined point and a second measurement position outside the object;

calculating difference data between the first distance data and the second distance data; and

deleting a part of the first distance data or the second distance data on the basis of the difference data,

when the second distance data cannot be measured due to interruption by a part of the object, acquiring the second distance data by assuming, as the predetermined point, an intersection point between a line connecting the predetermined point and the second measurement position and the surface of the object, at which a distance between the object and the second measurement position is shortest.

### REFERENCE SIGNS LIST

10 SYSTEM
11 PROCESSING DEVICE
111 ACQUISITION MEANS
112 DIFFERENCE CALCULATION MEANS
113 DIFFERENCE DELETION MEANS
12 DISTANCE MEASUREMENT DEVICE
13 FOREIGN BODY DETECTION DEVICE
51, 51a, 51b OBJECT
51a1, 51a2, 51b1, 51b2 END
p1 FIRST MEASUREMENT POSITION
p2 SECOND MEASUREMENT POSITION
x1 INTERSECTION POINT
pp, ppa, ppb PREDETERMINED POINT
pp1 FIRST PREDETERMINED POINT
pps1 FIRST SPECIFIC POINT
ppss1 FIRST PREDETERMINED SPECIFIC POINT
ppd DIFFERENCE POINT
ppd1 FIRST DIFFERENCE POINT
ppd2 SECOND DIFFERENCE POINT
ppd1a ADJACENT FIRST DIFFERENCE POINT
ppd2a ADJACENT SECOND DIFFERENCE POINT
ppn PLURALITY OF POINTS
d1, d11, d1a, d1b FIRST DISTANCE DATA
d2, d21, d2a, d2b SECOND DISTANCE DATA
d1r FIRST PREDETERMINED DISTANCE DATA
dd DIFFERENCE DATA
dd1 FIRST DIFFERENCE DISTANCE DATA
dd2 SECOND DIFFERENCE DISTANCE DATA
dd1r FIRST PREDETERMINED DIFFERENCE DISTANCE DATA
dd2r SECOND PREDETERMINED DIFFERENCE DISTANCE DATA
ddj ADJACENT DIFFERENCE DISTANCE DATA
A, B, D IMAGE
R PREDETERMINED DISTANCE
L1, L2 LINE
S1 SHADOW

What is claimed is:

1. A processing device comprising:
at least one memory storing instructions, and
at least one processor configured to execute the instructions to;
acquire first distance data between a predetermined point on a surface of an object and a first measurement position outside the object, and acquire second distance data between the predetermined point and a second measurement position outside the object;
calculate difference data between the first distance data and the second distance data; and
delete a part of the first distance data or the second distance data on the basis of the difference data,
wherein when the second distance data cannot be measured due to interruption by a part of the object, acquires the second distance data by assuming, as the predetermined point, an intersection point between a line connecting the predetermined point and the second measurement position and the surface of the object, at which a distance between the object and the second measurement position is shortest.

2. The processing device according to claim 1, wherein the at least one processor is further configured to:
specifies the first distance data where the difference data is equal to or greater than a difference threshold as first difference distance data,
specifies the predetermined point on the surface of the object corresponding to the first difference distance data as a first specific point,
specifies the predetermined point on the surface of the object included within a predetermined distance from a line connecting the first specific point and the second measurement position as a first predetermined specific point,
specifies the first distance data corresponding to the first predetermined specific point as first predetermined distance data, and
deletes the first predetermined distance data.

3. The processing device according to claim 1, wherein the at least one processor is further configured to:
specifies the first distance data where the difference data is equal to or greater than a difference threshold as first difference distance data, and
deletes the first difference distance data equal to or greater than the second distance data.

4. The processing device according to claim 3, wherein the difference threshold is equal to or greater than 0.

5. The processing device according to claim 1, wherein the at least one processor is further configured to:
specifies the first distance data where the difference data is equal to or greater than a difference threshold as first difference distance data,
specifies the predetermined point on the surface of the object corresponding to the first difference distance data as a first difference point,
specifies the second distance data where the difference data is equal to or greater than the difference threshold as second difference distance data,
specifies the predetermined point on the surface of the object corresponding to the second difference distance data as a second difference point,
specifies the predetermined point on the surface of the object adjacent to the first difference point as an adjacent first difference point,
specifies the predetermined point on the surface of the object adjacent to the second difference point as an adjacent second difference point,
calculates first predetermined difference distance data between the first difference point and the second difference point,
calculates second predetermined difference distance data between the adjacent first difference point and the adjacent second difference point,
calculates adjacent difference distance data between the second difference point and the adjacent second difference point,
calculates a first gradient by dividing the adjacent difference distance data by a distance obtained by subtracting the first predetermined difference distance data from the second predetermined difference distance data, and
when the first gradient is greater than a gradient threshold, deletes the first difference distance data.

6. The processing device according to claim 1, wherein a plurality of predetermined points on the surface of the object are equally spaced from one another.

7. The processing device according to claim 1, wherein a plurality of predetermined points on the surface of the object are arranged along a first direction and arranged along a second direction perpendicular to the first direction.

8. The processing device according to claim 1, further comprising:
a display unit configured to display the predetermined point on the surface of the object corresponding to the first distance data or the second distance data together with the object.

9. A system comprising:
a distance measurement device;
a processing device; and
a foreign body detection device, wherein
the distance measurement device measures first distance data between a predetermined point on a surface of an object and a first measurement position outside the object, and measures second distance data between the predetermined point and a second measurement position outside the object,
the processing device includes:
at least one memory storing instructions, and
at least one processor configured to execute the instructions to;
acquire the first distance data and the second distance data;
calculate difference data between the first distance data and the second distance data; and
delete a part of the first distance data or the second distance data on the basis of the difference data, and
when the second distance data cannot be measured due to interruption by a part of the object, acquires the second distance data by assuming, as the predetermined point, an intersection point between a line connecting the predetermined point and the second measurement position and the surface of the object, at which a distance between the object and the second measurement position is shortest, and
the foreign body detection device detects a foreign body on the basis of the first distance data after the deletion and the second distance data after the deletion.

10. The system according to claim 9, wherein the at least one processor is further configured to:
specifies the first distance data where the difference data is equal to or greater than a difference threshold as first difference distance data,
specifies the predetermined point on the surface of the object corresponding to the first difference distance data as a first specific point,
specifies the predetermined point on the surface of the object included within a predetermined distance from a line connecting the first specific point and the second measurement position as a first predetermined specific point,
specifies the first distance data corresponding to the first predetermined specific point as first predetermined distance data, and
deletes the first predetermined distance data.

11. The system according to claim 9, wherein the at least one processor is further configured to:
specifies the first distance data where the difference data is equal to or greater than a difference threshold as first difference distance data, and
deletes the first difference distance data equal to or greater than the second distance data.

12. The system according to claim 9, wherein the at least one processor is further configured to:
specifies the first distance data where the difference data is equal to or greater than a difference threshold as first difference distance data,
specifies the predetermined point on the surface of the object corresponding to the first difference distance data as a first difference point,
specifies the second distance data where the difference data is equal to or greater than the difference threshold as second difference distance data,
specifies the predetermined point on the surface of the object corresponding to the second difference distance data as a second difference point,
specifies the predetermined point on the surface of the object adjacent to the first difference point as an adjacent first difference point,
specifies the predetermined point on the surface of the object adjacent to the second difference point as an adjacent second difference point,
calculates first predetermined difference distance data between the first difference point and the second difference point,
calculates second predetermined difference distance data between the adjacent first difference point and the adjacent second difference point,
calculates adjacent difference distance data between the second difference point and the adjacent second difference point,
calculates a first gradient by dividing the adjacent difference distance data by a distance obtained by subtracting the first predetermined difference distance data from the second predetermined difference distance data, and
when the first gradient is greater than a gradient threshold, deletes the first difference distance data.

13. A method comprising:
acquiring first distance data between a predetermined point on a surface of an object and a first measurement position outside the object;
acquiring second distance data between the predetermined point and a second measurement position outside the object;
calculating difference data between the first distance data and the second distance data;
deleting a part of the first distance data or the second distance data on the basis of the difference data; and
when the second distance data cannot be measured due to interruption by a part of the object, acquiring the second distance data by assuming, as the predetermined point, an intersection point between a line connecting the predetermined point and the second measurement position and the surface of the object, at which a distance between the object and the second measurement position is shortest.

14. (canceled)
